(19) United States
(12) Patent Application Publication
(10) Pub. No.: US 2007/0007020 A1
(43) Pub. Date: Jan. 11, 2007

(54) Thermal detector for fire suppression system

(75) Inventor: Barry David Chase, New Bedford, MA (US)

Correspondence Address: MERCHANT & GOULD PC, P.O. BOX 2903, MINNEAPOLIS, MN, 55402-0903, US

(73) Assignee: Kidde Fenwal, Inc.

(21) Appl. No.: 11/179,160

(22) Filed: Jul. 11, 2005

(51) Int. Cl. A62C 37/12

(52) U.S. Cl. 169/57; 169/60; 169/42

(57) ABSTRACT

A thermal detector for creating an actuation signal in response to an elevated temperature condition includes an energy storage system having a movable member movable between a first position and a second position and a biasing member for urging the movable member to the second position. A thermal sensor includes a degradable member positioned holding the movable member in the first position against a bias of the biasing member. The degradable member is selected to degrade in response to an elevated temperature.

### I. BACKGROUND OF THE INVENTION

1. Field of the Invention

This invention pertains to apparatus for suppressing fires. More particularly, this invention pertains to an apparatus for actuating a fire suppression system.

2. Description of the Prior Art

Fire suppression systems are used in a wide variety of applications. A common fire suppression system will include a fire suppressant and an actuator for activating delivery of the fire suppressant to a site. For example, the fire suppressant may be contained within a pressurized container. The activation mechanism may include an activation head in the form of a valve coupled to the container for release of the fire suppressant upon actuation of the valve. The fire suppressant is delivered through tubing or the like to a nozzle, which is directed at a potential fire location. Fire suppression systems may be provided in buildings, transportation equipment such as vehicles, vessels or other installations where fire is a threat.

Not uncommonly, fire suppression systems may include automatic activation systems in the event of a detected fire. For example, buildings are commonly provided with nozzles having a mechanical thermal sensor, which degrades in response to heat. Such sensors may be a eutectic metal or thermal bulb technology, which degrades (such as melting or breaking) upon being exposed to a set temperature. In the event of such degradation of the element, the fire suppressant may be released through a nozzle.

Remote mechanical thermal detectors are also known in the prior art. An example of a mechanical thermal detector utilizes a mechanical thermal sensor coupled to the actuation head of a suppressant container by a cable under tension. In response to an elevated temperature, a mechanical thermal sensor may break or melt resulting in loss of tension on the cable. The loss of tension is detected at a control box. A control box houses a spring and a ratchet device to supply tension in the cable and the mechanical thermal sensor is located remote from the spring and ratchet assembly and in-line with the tension cable. The use of a tensioned cable limits the flexibility of installation and requires additional hardware, such as pulleys and brackets, to maintain tension in the cable over the life of the system. An example of such a prior art system is described in “Kidde WHDR™ Wet Chemical Fire Suppression System, Addendum No. 6 to Installation, Operation and Maintenance Manual, Part No. 87-12200-001, UL EX 3559, Design and Installation Instructions for XV Control Systems”, dated September 2002 and published by the assignee of the present invention. See, e.g., FIG. AD6-10 on page AD6-6 of that document.

It is an object of the present invention to provide a mechanical thermal detector and a fire suppression system associated therewith which avoids the limitations of the prior art.

### II. SUMMARY OF THE INVENTION

According to a preferred embodiment of the present invention, a fire suppression apparatus includes a container of a fire suppressant and an actuation head for releasing the fire suppressant from the container. The system further includes a thermal detector having an energy storage system. The energy storage system includes a movable member (which moves between a first position and a second position) and a biasing member for urging the movable member to the second position. The thermal detector further includes a thermal housing having a degradable member. The degradable member is positioned holding the moveable member in the first position against a bias of the biasing member. The degradable member is selected to degrade in response to an elevated temperature. A transmission member transmits an actuating signal to the actuation head in response to movement of the movable member to the second position. The actuation head is adapted to be activated in response to the signal. The signal may be movement of a mechanical coupling or may be an electrical signal generated by a control member coupled to the thermal detector.

### III. BRIEF DESCRIPTION OF THE DRAWINGS

FIG. 1 is a schematic representation of a fire suppression system according to the present invention;

FIG. 2 is a schematic representation of an alternative embodiment of a fire suppression system according to the present invention;

FIG. 3 is a side sectional schematic representation of a mechanical detection system according to the present invention;

FIG. 4A is a plan view of an interior of the detection system of the present invention showing a mechanical energy storage system and showing a thermal sensor holding the storage system in a pre-actuated state;

FIG. 4B is a side elevation view of the elements of FIG. 4A;

FIG. 5A is the view of FIG. 4A showing following thermal degradation of the thermal sensor and showing the mechanical energy storage system in an actuated state; and

FIG. 5B is a side elevation view of the elements of FIG. 5A.

### IV. DESCRIPTION OF THE PREFERRED EMBODIMENT

With reference now to the various drawing figures in which identical elements are numbered identically throughout, a description of the preferred embodiment of the present invention will now be provided. In a preferred embodiment, the present invention is provided to activate a fire suppression system on a marine vessel or the like. However, it will be appreciated that the present invention is applicable to a wide variety of applications including vehicles, buildings or other structures.

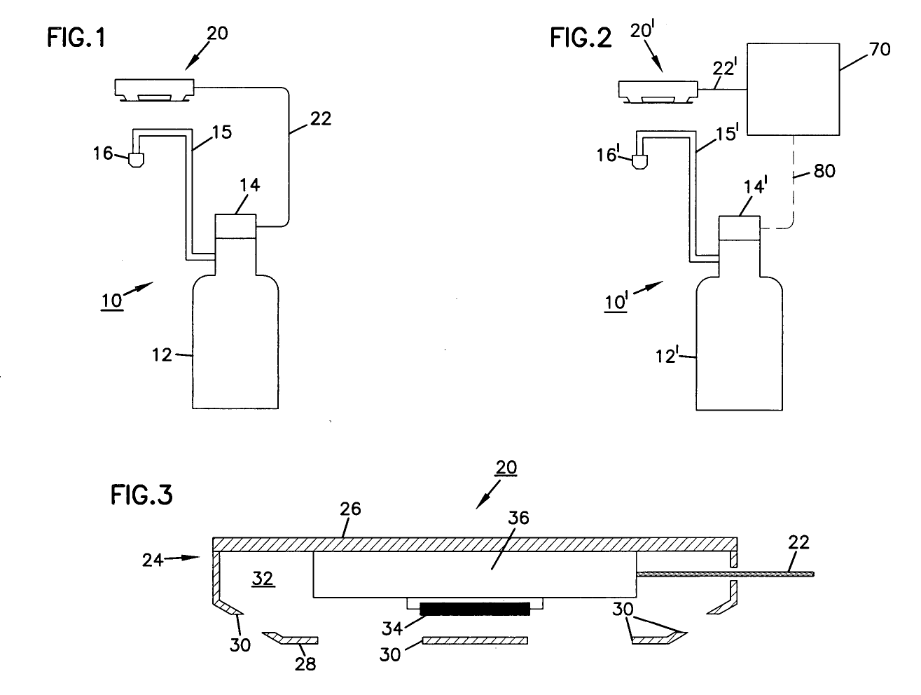

With initial reference to FIG. 1, a representative fire suppression system 10 is shown according to the present invention. The system 10 includes a container 12 and an actuation head 14. The container 12 contains, under pressure, a fire suppressant.

The actuation head 14 includes a valve (not shown) for release of the suppressant from the container 12 upon actuation of the head 14. Such actuation permits the flow of the pressurized suppressant through a discharge pipe 15 to a nozzle 16.

It will be appreciated that cylinders for containing a pressurized fire suppressant are commercially available items. An example of such is commercial product 83-131010-001 of Kidde Fenwal, Ashland, Mass., U.S.A. or 372555 of Kidde Aerospace, Wilson, N.C., U.S.A. Actuation heads are also well known products and an example of such is product part no. 979469 of Kidde Fenwal, Ashland, Mass., U.S.A. Such actuation heads 14 actuate a movable valve, which moves from a closed position (preventing release of suppressant from the container 12) to an open position (discharging suppressant through the discharge pipe 15 and nozzle 16) upon movement of the valve.

The present invention includes a novel arrangement for detecting a fire and actuating the actuation head 14. The novel actuation mechanism includes a thermal detector 20 connected to the actuation head 14 by a transmission member 22. In the preferred embodiment of FIG. 1, the transmission member 22 is a cable for displacing the valve of the actuation head 14 as will be described.

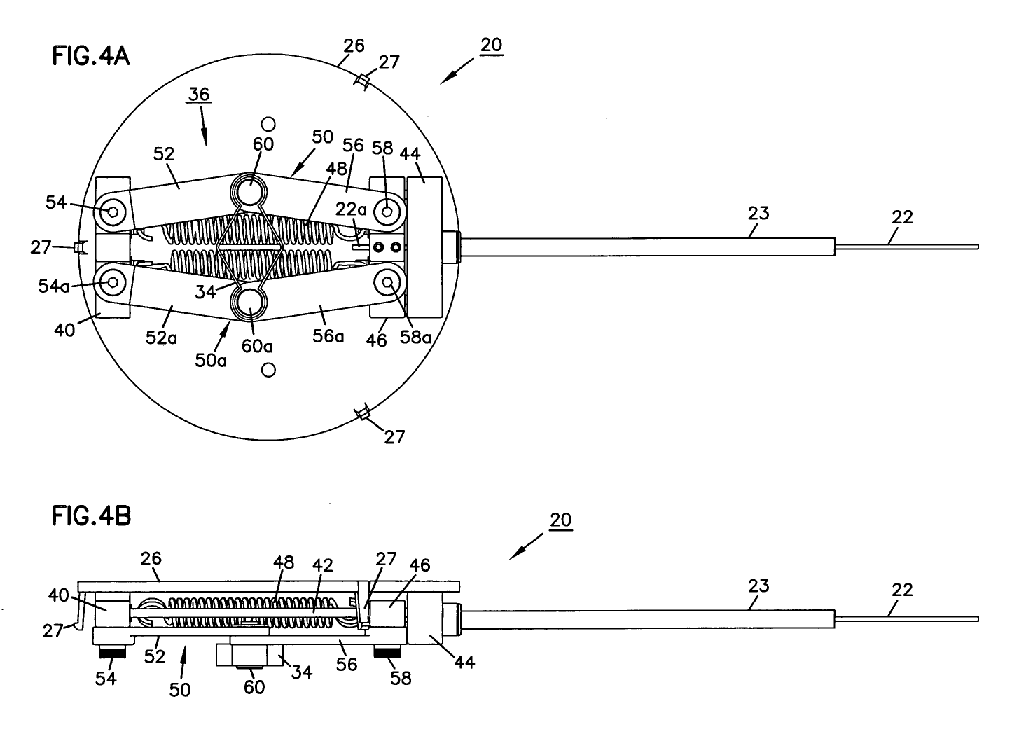

With reference to FIGS. 3, 4A, 4B, 5A and 5B, the detector 20 includes a housing 24 having a support plate 26 and a vented cover 28. The support plate 26 is attached to the cover 28 by clips 27 (shown, for example, in FIGS. 4A and 4B).

The housing 24 is mounted in a location for detecting elevated temperatures resulting from a fire. The cover 28 includes a plurality of hot air vents 30 for admitting flow of hot air from a fire threat environment to an interior 32 of the housing 24.

Contained within the housing interior 32 are a thermal sensor 34 and an energy storage system 36. The energy storage system 36 and thermal sensor 34 are mounted on the support plate 26.

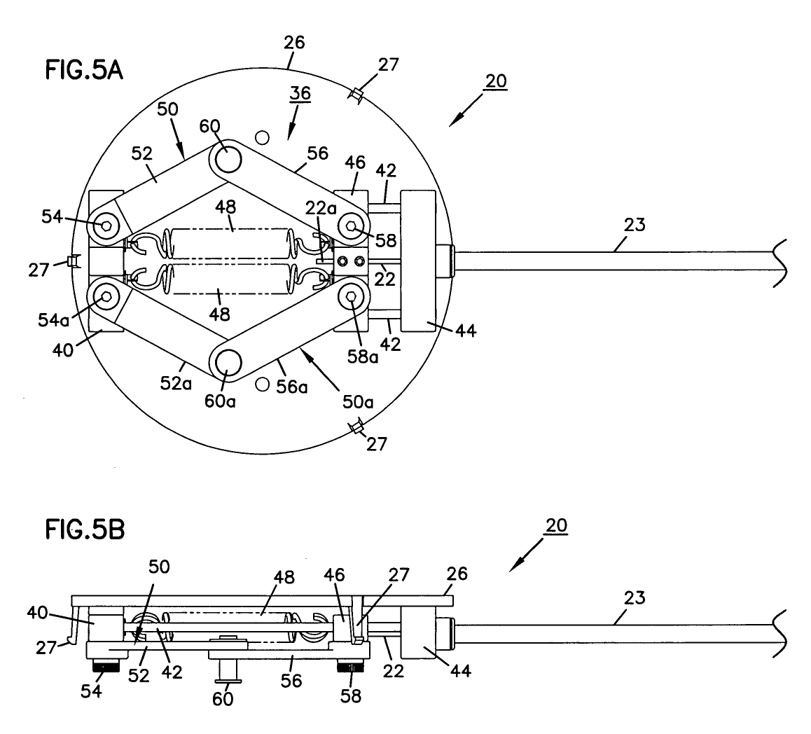

FIGS. 4A and 4B show the thermal elements in a cocked or loaded state prior to activation of the actuation head 14. FIGS. 5A and 5B illustrate these elements in released state for activating the actuation head 14.

The thermal detector includes spaced apart first and second fixed members 40, 44, each mounted in a fixed position on the support plate 26. Parallel and spaced apart bars 42 extend between the plates 40, 44.

The plates 40, 44 and bars 42 define a track, which carries a movable member 46 in the form of a plate having holes, which receive the bars 42. Accordingly, the plate 46 can move on the bars 42 between the plates 40 and 44 in a linear path.

With the movable member 46 adjacent the second fixed plate 44, the movable member 46 is in a first position associated with a loaded state in which a fire is not detected and the actuation head 14 is not activated (FIGS. 4A and 4B). When the movable plate 46 is moved away from the second plate 44 towards the first fixed plate 40 (as illustrated in FIGS. 5A and 5B), the movable member 46 is in a second position associated with a detected fire and activation of the actuation head 14.

Springs 48 are provided as biasing members extending between the first fixed member 40 and a movable member 46. Accordingly, when the movable member 46 is in the first position adjacent the second fixed plate 44 (FIGS. 4A and 4B), the springs 48 are stretched to store energy and create a bias for urging the movable member 46 to the second position illustrated in FIGS. 5A and 5B.

First and second linkages 50, 50a connect the first fixed member 40 and the movable member 46. Each of the linkages 50, 50a includes a first lever arm 52, 52a pivotally connected to the first fixed member 40 at a pivot connection 54, 54a. The linkages 50, 50a further include a second lever arm 56, 56a pivotally connected to the movable member 46 at a pivot connection 58, 58a. The first and second lever arms 52, 56 and 52a, 56a are joined at pivot pins 60, 60a.

The combined length of the lever arms 52, 56 and 52a, 56a is greater than the spacing between the first and second fixed members 40, 44. The length is selected so that, when the movable member 46 is adjacent the second fixed member 44, the longitudinal axes of the connected lever arms 52, 56 and 52a, 56a are substantially aligned as illustrated in FIG. 4A. When the movable member 46 is moved away from the second fixed member 44 to the second position of FIG. 5A, the angle between the longitudinal axis of the connected lever arms 52, 56 and 52a, 56a diminishes and the spacing between the pivot pins 60, 60a increases.

Accordingly, as detector 20 is cocked to the loaded position of FIGS. 4A and 4B, the pivot pins 60, 60a are urged towards one another and the movable member 46 is urged against the bias of the springs 48 to the first position abutting the second fixed member 44. In the absence of a retainer member holding the spacing between the pivot pins 60, 60a fixed, the springs 48 urge the movable member 46 to move toward the second position of FIG. 5A.

The thermal sensor 34 surrounds the opposing pins 60, 60a to hold the opposing pins 60, 60a in their position of FIG. 4A. The thermal sensor 34 is, in a preferred embodiment, a eutectic metal band surrounding the pins 60, 60a and holding the pins 60 close together as shown in FIG. 4A. The thermal sensor 34 is a metal clip of eutectic metal, which melts in response to an elevated temperature. It will be appreciated that such materials are well known in the art. Alternatively, the thermal sensor 34 may be a thermal bulb, which breaks in response to an elevated temperature. Again, such thermal bulbs are known in the art and form no part of this invention per se.

In the embodiments of FIGS. 4A through 5B, the transmission member 22 is shown as a cable having a first end 22a connected to the movable member 46 and a second end directly connected to the actuation head 14. The cable 22 resides in a conduit 23 to protect the cable 22 from mechanical injury.

In response to an elevated temperature, the thermal sensor 34 degrades by melting. This degradation causes the movable member 46 to move toward the first member 40 in response to the bias of the springs 48. This motion results in displacement of the cable 22, which is connected to a valve (not shown) of the actuator 14, to move the valve of the actuator 14 to an open position resulting in release of the suppressant from the container 12.

FIG. 2 illustrates an alternative embodiment. In FIG. 2 all elements in common with those of FIG. 1 are similar numbered with the addition of an apostrophe to distinguish the embodiments.

In the embodiment of FIG. 2, the cable 22′ is connected to a control box 70 which may include electrical components such as switches or the like for creating a secondary actuation signal 80 which is then connected to the actuation head 14′. For example, the actuation head 14′ may include a solenoid for moving the valve of the actuation head 14′ with the solenoid being energized by the electrical signal from the control box 70. With the embodiment of FIG. 2, multiple electrical signal paths 80 may come off of a single control box 70 to multiple actuation heads 14′ associated with multiple fire suppressant cylinders 12′. In this embodiment, a single mechanical thermal detector 20′ may actuate the operation of a plurality of fire suppressant containers 12′.

With the invention thus described, the energy storage system (which in a preferred embodiment includes the spring members 48) is housed in the same housing 24 as the thermal sensor 34 (both of which may be remote from the suppressant container 12). With this embodiment, the cable 22 need not be maintained under precise tension as was the limitation with prior art designs. Further, equipment necessary to maintain desired cable tension in the prior art (such as pulleys and brackets and the like), are eliminated with the design on the present invention.

It has been shown how the objects of the invention have been attained in a preferred embodiment, modifications and equivalents of the disclosed concepts may occur to one of ordinary skill in the art. The invention is adapted to many different uses in addition to those described above. It is intended the modifications and equivalents shall be included within the scope of the claims, which are appended hereto.

We claim:

1. A fire suppression apparatus comprising:
a. a container of a fire suppressant;
b. an actuation head for releasing said fire suppressant from said container upon activation of said actuation head;
c. a thermal detector including:
A. an energy storage system including:
(1) a movable member movable between a first position and a second position;
(2) a biasing member for urging said movable member to said second position;
B. a thermal sensor including a degradable member positioned holding said movable member in said first position against a bias of said biasing member with said degradable member selected to degrade in response to an elevated temperature;
d. a transmission member for transmitting to said actuation head an actuating signal indicating movement of said movable member to said second position with said actuation head adapted to be activated in response to said signal.

2. An apparatus according to claim 1 wherein said thermal detector is remote from said actuation head and said transmission member includes a mechanical coupling between said movable member and said actuation head and said actuating signal is a movement of said coupling.

3. An apparatus according to claim 1 wherein said thermal detector is remote from said actuation head and said transmission member includes a control member for creating an electrical signal as said actuating signal.

4. An apparatus according to claim 1 wherein said thermal detector further includes:
a. a track for guiding movement of said movable member between said first and second positions;
b. said biasing member including a spring coupled to said movable member and a fixed position with said spring disposed to urge said movable member to said second position.

5. An apparatus according to claim 4 wherein:
a. said track extends in a path between a fixed member and said movable member with said first position near said fixed member and said second position further spaced from said fixed member;
b. said spring extending in said path between said fixed member and said movable member.

6. An apparatus according to claim 5 further comprising:
a linkage between said fixed member and said movable member and having a displaceable pivot location for accommodating movement of said movable member between said first and second positions;
said thermal sensor connected to said pivot location to prevent displacement of said pivot location prior to degradation of said degradable member.

7. A thermal detector for creating an actuation signal in response to an elevated temperature condition, said thermal detector comprising:
an energy storage system including:
a movable member movable between a first position and a second position;
a biasing member for urging said movable member to said second position;
a thermal sensor including a degradable member positioned holding said movable member in said first position against a bias of said biasing member with said degradable member selected to degrade in response to an elevated temperature.

8. A thermal detector according to claim 7 further comprising:
a track for guiding movement of said movable member between said first and second positions;
said biasing member including a spring coupled to said movable member and a fixed position with said spring disposed to urge said movable member to said second position.

9. A thermal detector according to claim 8 wherein:
said track extends in a path between a fixed member and said movable member with said first position near said fixed member and said second position further spaced from said fixed member;
said spring extending in said path between said fixed member and said movable member.

10. A thermal detector according to claim 9 further comprising;
a linkage between said fixed member and said movable member and having a displaceable pivot location for accommodating movement of said movable member between said first and second positions;
said thermal sensor connected to said pivot location to prevent displacement of said pivot location prior to degradation of said degradable member.
